(19) United States
(12) Patent Application Publication
(10) Pub. No.: US 2026/0239179 A1
(43) Pub. Date: Aug. 13, 2026

(54) SYSTEM AND METHODS FOR SERVICE DISCOVERY AND NEGOTIATION IN ULTRA-WIDEBAND COMMUNICATION

(71) Applicant: Qorvo US, Inc., Greensboro, NC (US)

(72) Inventors: Eric Perraud, Plaisance du Touch (FR); Guillaume Vivier, Paris (FR)

(21) Appl. No.: 19/142,738

(22) PCT Filed: Dec. 21, 2023
(86) PCT No.: PCT/US2023/085545

§ 371 Date: Jun. 24, 2025

Related U.S. Application Data
(60) Provisional application No. 63/480,267, filed on Jan. 17, 2023.
(60) Provisional application No. 63/510,345, filed on Jun. 26, 2023.

(51) Int. Cl. H04W 48/16; H04B 1/7163; H04W 64/00

(52) U.S. Cl. CPC H04W 48/16; H04B 1/7163; H04W 64/00

(57) ABSTRACT

A method for method for in-band service discovery in ultra-wideband (UWB) communication. The method includes transmitting, in a first time period, a service announcement message comprising a list of data services to a UWB device; receiving, in the first time period, a response message to the service announcement message from the UWB device, the response message comprising a chosen one of the data services; exchanging, in a second time period, a configuration parameter associated with the chosen one of the data service for UWB data transfer with the UWB device; and performing, in a third time period, a UWB ranging for the UWB data transfer.

### CROSS-REFERENCE TO RELATED APPLICATIONS

The present application claims the benefit of U.S. Provisional Application No. 63/480,267, filed Jan. 17, 2023 and U.S. Provisional Application No. 63/510,345, filed Jun. 26, 2023, which are incorporated herein by reference in their entirety.

### FIELD OF THE DISCLOSURE

The present disclosure relates to ultra-wideband-enabled devices and systems for facilitating service discovery and negotiation and negotiation in ultra-wideband (UWB) communication, in particular, to wireless payment solutions that enables advertising and responding using UWB communication to reduce the reliance on non-UWB technologies when performing UWB ranging.

### BACKGROUND

Ultra-wideband (UWB) is a radio technology that is able to use a very low energy level for short-range, high-bandwidth communications over a large portion of the radio spectrum. For example, UWB technology can be used in ranging, which is a process of determining the distance between two devices using UWB technology. UWB technology can also be used in short-range data transactions. Today, UWB technology is used in various applications that involve short-range ranging and data transactions, such as, for example, contactless payment at parking stations and point of sales (POS's).

Currently, UWB technology is mainly used in UWB ranging between two UWB devices (e.g., a controller UWB device and a controlee UWB device). The existing UWB ranging relies on the establishment of a UWB ranging session between the controller UWB device and the controlee UWB device. The UWB ranging session is often preceded by an out-of-band (OOB) procedure where both the controller UWB device and the controlee UWB device discover themselves, exchange their UWB capabilities, create the root keys to derive the keys for a secure ranging, and negotiate the configuration of the UWB ranging session. This OOB procedure is currently donc using Bluetooth (i.e., BLE).

However, challenges still exist. For example, the use of the OOB procedure often requires an additional chip to enable the OOB functions, potentially increasing the complexity and manufacturing cost of the UWB devices. Thus, methods and system that can lower the hardware requirement without increasing the cost are desired.

### SUMMARY

Embodiments of the present disclosure provide a method for in-band service discovery in ultra-wideband (UWB) communication. The method includes: transmitting, in a first time period, a service announcement message including a list of data services to a UWB device; receiving, in the first time period, a response message to the service announcement message from the UWB device, the response message including a chosen one of the data services; exchanging, in a second time period, a configuration parameter associated with the chosen one of the data service for UWB data transfer with the UWB device; and performing, in a third time period, a UWB ranging for the UWB data transfer.

In some embodiments, the first time period includes a UWB contention-based period to discover the UWB device and a plurality of slots following the service announcement message.

In some embodiments, the service announcement message is embedded in a poll message at a beginning of the first period before the UWB contention-based period.

In some embodiments, the second time period includes a UWB data period subsequent to the first period by a predetermined time delay.

In some embodiments, the method further includes scheduling the second time period subsequent to the first period by the predetermined time delay upon receiving the response message.

In some embodiments, the method further includes performing a UWB ranging operation with the UWB device in the second time period to obtain a distance to the UWB device.

In some embodiments, the service announcement message includes a link layer message and each of the data services is associated with an identification number.

In some embodiments, the response message includes a link layer message and includes an identification number of the chosen one of the data services.

In some embodiments, the response message further includes an attribute of the chosen one of the data services.

In some embodiments, the service announcement message is part of a one way ranging (OWR) packet located in a time slot at the beginning of the first time period before the UWB contention-based period.

In some embodiments, the first time period and the second time period are hybrid ranging periods of a hybrid session.

In some embodiments, the UWB ranging includes a two-way ranging (TWR).

In some embodiments, the service announcement message is constructed on a predefined configuration of a physical layer and a medium access control (MAC) layer.

Embodiments of the present disclosure provide a method for in-band service discovery in ultra-wideband (UWB) communication. The method includes: receiving, in a first time period, a service announcement message including a list of data services from a UWB device; transmitting, in the first time period, a response message to the service announcement message to the UWB device, the response message including a chosen one of the data services; exchanging, in a second time period, a configuration parameter associated with the chosen one of the data service for UWB data transfer with the UWB device; and performing, in a third time period, a UWB ranging for the UWB data transfer.

In some embodiments, the first time period includes a UWB contention-based period.

In some embodiments, the second time period includes a UWB data period subsequent to the first period by a predetermined time delay.

In some embodiments, the method further includes, preparing the configuration parameter for the exchanging by an end of the predetermined time delay and based on the response message.

In some embodiments, the service announcement message includes a link layer message and each of the data services is associated with an identification number.

In some embodiments, the response message includes a link layer message and includes an identification number of the chosen one of the data services.

In some embodiments, the response message further includes an attribute of the chosen one of the data services.

Embodiments of the present disclosure provide an ultra-wideband (UWB) device. The UWB device includes a transceiver operable to perform a UWB communication; a memory for storing program instructions and a list of data services, each of the data services being associated with an identification number; and a processor coupled to the transceiver and to the memory. The processor is operable to execute the program instructions, which, when executed by the processor, cause the UWB device to perform the following to facilitate in-band service discovery for a UWB device: transmitting, in a first time period, a service announcement message including a list of data services to the UWB device; receiving, in the first time period, a response message to the service announcement message from the UWB device, the response message including a chosen one of the data services; exchanging, in a second time period, a configuration parameter associated with the chosen one of the data service for UWB data transfer with the UWB device; and performing, in a third time period, a UWB ranging for the UWB data transfer.

In some embodiments, the first time period includes a UWB contention-based period to discover the UWB device and a plurality of slots following the service announcement message.

In some embodiments, the service announcement message is embedded in a poll message located at a beginning of the first period before the UWB contention-based period.

In some embodiments, the second time period includes a UWB data period subsequent to the first period by a predetermined time delay.

In some embodiments, the operations further include scheduling the second time period subsequent to the first period by the predetermined time delay upon the receiving of the response message.

In some embodiments, the operations further include performing a UWB ranging operation with the UWB device in the second time period to obtain a distance to the UWB device.

In some embodiments, the service announcement message includes a link layer message and each of the data services is associated with an identification number.

In some embodiments, the response message includes a link layer message and includes an identification number of the chosen one of the data services.

In some embodiments, the response message further includes an attribute of the chosen one of the data services.

In some embodiments, the service announcement message is part of a one way ranging (OWR) packet located in a time slot at the beginning of the first time slot before the UWB contention-based period.

In some embodiments, the first time period and the second time period are hybrid ranging periods of a hybrid session.

In some embodiments, the UWB ranging includes a two-way ranging (TWR).

In some embodiments, the service announcement message is constructed on a predefined configuration of a physical layer and a medium access control (MAC) layer. Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates an exemplary environment with ultra-wideband (UWB) devices for implementing in-band service discovery and negotiation, according to some aspects of the present disclosure.

FIG. 1B illustrates with an exemplary system and exemplary UWB devices for in-band service discovery and negotiation, according to some aspects of the present disclosure.

FIG. 1C illustrates a signaling diagram between a controller UWB device and a controlee UWB device in in-band service discovery and negotiation, according to some aspects of the present disclosure.

FIG. 1D illustrates frame structures used in in-band service discovery and negotiation, according to some aspects of the present disclosure.

FIG. 2A illustrates an exemplary in-band service discovery and negotiation, according to some aspects of the present disclosure.

FIGS. 2B and 2C illustrate exemplary architectures of UWB devices for implementing in-band service discovery and negotiation, according to some aspects of the present disclosure.

FIG. 2D illustrates an exemplary in-band negotiation session and a UWB ranging session between a controller UWB device and a controlee UWB device, according to some aspects of the present disclosure.

FIG. 3A illustrates another exemplary in-band service discovery and negotiation, according to some aspects of the present disclosure.

FIG. 3B illustrates an exemplary architecture of a controller UWB device for implementing in-band service discovery and negotiation, according to some aspects of the present disclosure.

FIG. 4A illustrates an exemplary method for a controller UWB device to implement in-band service discovery and negotiation, according to some aspects of the present disclosure.

FIG. 4B illustrates an exemplary method for a controlee UWB device to implement in-band service discovery and negotiation, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled user device” or simply user device).

In this disclosure, each of “phase,” a “sub-session,” a “hybrid ranging round,” and “a session” includes a period of time, and can each be used interchangeably with “time period” when necessary. A session may include a plurality of sub-sessions/phases. A session may include one or more rounds. A hybrid session may include a plurality of hybrid ranging rounds, each including one or more sub-sessions/phases. In this disclosure, “controller,” “controller device,” and “controller UWB device” may be used interchangeably; and “controlee,” “controlee device,” and “controlee UWB device” may be used interchangeably.

As previously described, UWB ranging between two UWB devices relies on OOB discovery and negotiation to establish a UWB channel for ranging. The OOB discovery and negotiation often includes a FiRa device and FiRa profile discovery, an OOB channel establishment, and a UWB capabilities exchange. Optionally, the OOB discovery and negotiation also includes a secure channel setup and a service data exchange between the OOB channel establishment and the UWB capabilities exchange, and/or a UWB session key exchange after the UWB capabilities exchange. Currently, the OOB discovery and negotiation is based on BLE. However, methods, system, and UWB devices that do not rely on the OOB procedure are desired to reduce cost and complexity of UWB communication.

Embodiments of the present disclosure provide system and methods for in-band (i.e., UWB) service discovery and negotiation that is compatible with the existing FiRa specification. The in-band procedure may include existing steps/operations done with the OOB technology (e.g., secure channel setup, service data exchange, UWB capabilities exchange, and UWB session key exchange), and may be performed using a UWB channel between the UWB devices. In this disclosure, a controller UWB device broadcasts a service announcement message containing a list of the services (e.g., data services) it provides to a controlee UWB device in a contention-based session/sub-session, which is typically used for discovering new UWB devices but not service discovery and negotiation in existing UWB communication. Each of the services is associated with an identification (ID) number. The controlee UWB device may select a random slot in the contention-based window and send a response message in the selected slot to choose a service. After receiving the controlee UWB device's response, the controller UWB device may schedule an in-band negotiation session to exchange predefined configuration parameters for the selected service with the controlec UWB device. If the controller UWB device does not receive any response message (e.g., no controlee UWB device is interested in any of the services), the controller UWB device may not schedule an in-band negotiation session. After the negotiation, the controller UWB device may schedule a contention-free period (CFP) session, such as two-way ranging (TWR) and/or data transfer, to execute the service.

In some embodiments, the service announcement message is a link layer (LL) packet data unit (PDU) that is part of a poll message, followed by a contention-based window. The controlee's response message may be transmitted in a random slot in the contention-based window, and carries a LL PDU which indicates the service that the controlee has selected. In some embodiments, the in-band service discovery and negotiation are in a hybrid session. The service announcement message is a LL PDU appended to a one-way ranging (OWR) advertisement packet at the beginning of a hybrid ranging round of the hybrid session. In some embodiments, the OWR and the LL PDU may be followed by a poll message and a contention-based window in the same hybrid ranging round. The controlee's response message may be transmitted in a random slot in the same contention-based window, and may carry a LL PDU which indicates the service that the controlee has selected. After receiving the controlee UWB's chosen service, the controller UWB device may schedule a phase for negotiation in the subsequent hybrid ranging round. Thus, service discovery and negotiation may be achieved using UWB (e.g., in-band) technology.

The LL PDU's may each include a dedicated message type and the list of services provided by the applications (e.g., upper layers) of the controller UWB device. The LL PDU's may each be embedded in a medium access control (MAC) layer payload that is transmitted to the controlee UWB device. The proposed LL PDU's are compatible with existing UWB communication systems, and can be generated by a dedicated link layer controller or a general controller of the UWB devices.

The present disclosure proposes a predefined contention-based session for service announcement and user client discovery, and a predefined hybrid session to support service announcement and user client discovery. A new LL PDU (service announcement PDU) may be appended as a FiRa data message in the contention-based poll frame of the predefined contention-based session. The PDU carries an upper layer service list. Alternatively, this service announcement PDU can be the advertised payload of an OWR session/sub-session/phase, e.g., scheduled in a hybrid session. In the present disclosure, the upper layer of the application client is involved in the response frame to find a service of interest among the supported services. In the present disclosure, a new LL PDU (service selection PDU) is appended as a FiRa data message in the response frame. The PDU carries the ID of the selected service (and optionally its attributes). In other words, the LL PDU service announcement and LL PDU service selection are not proposed in the current specification. The present disclosure also provides a predefined time-based session for in-band session negotiation and schedule this session if a new user responds with an ID of the service of interest. The present disclosure is simple to implement. The proposed solution “re-uses” the existing FiRa underlying mechanisms such as contention-based scheduling session and existing contention based frames. The OOB connection can thus be replaced by reusing the existing FiRa framework.

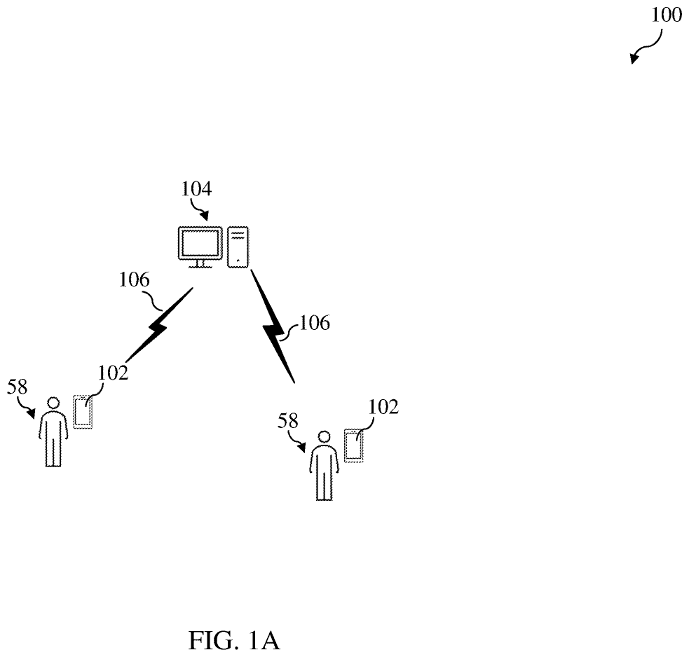

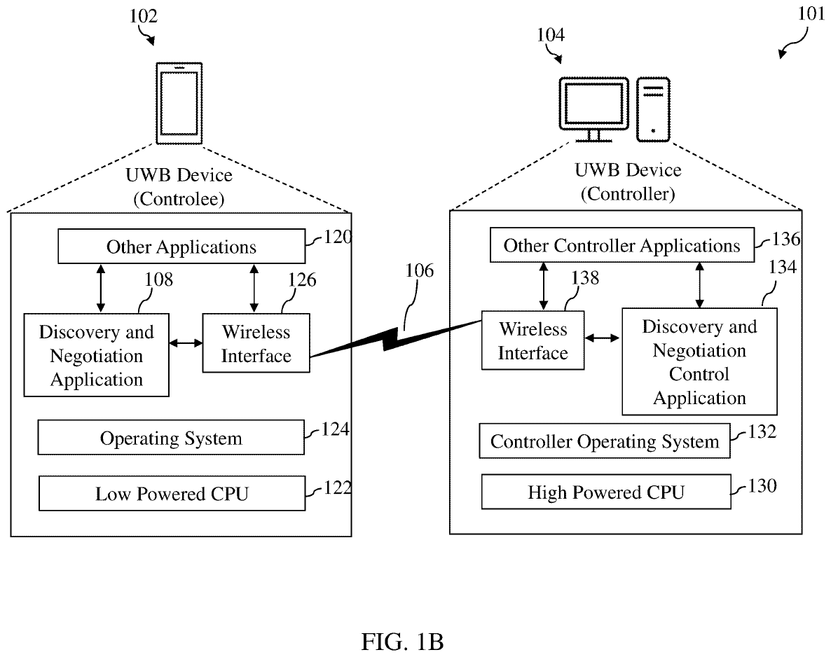

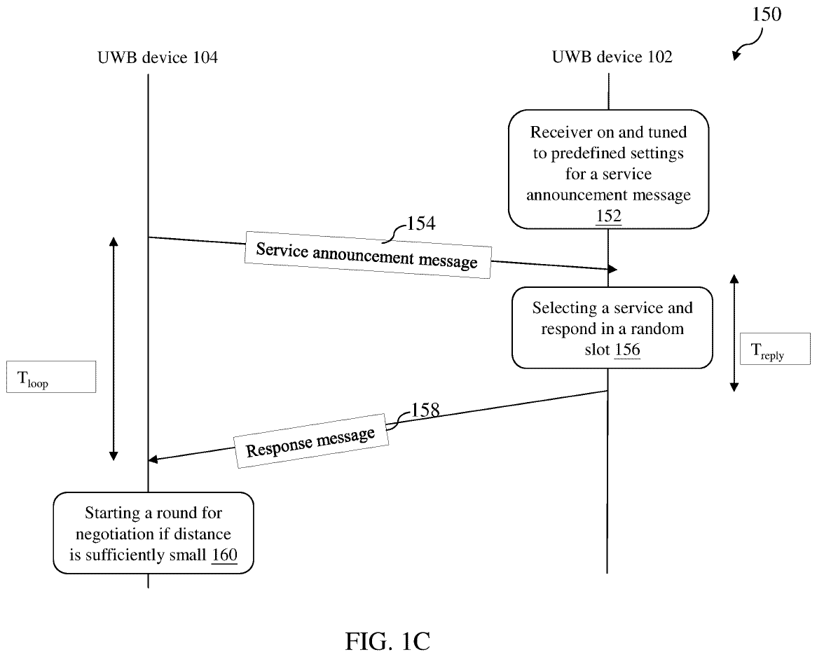

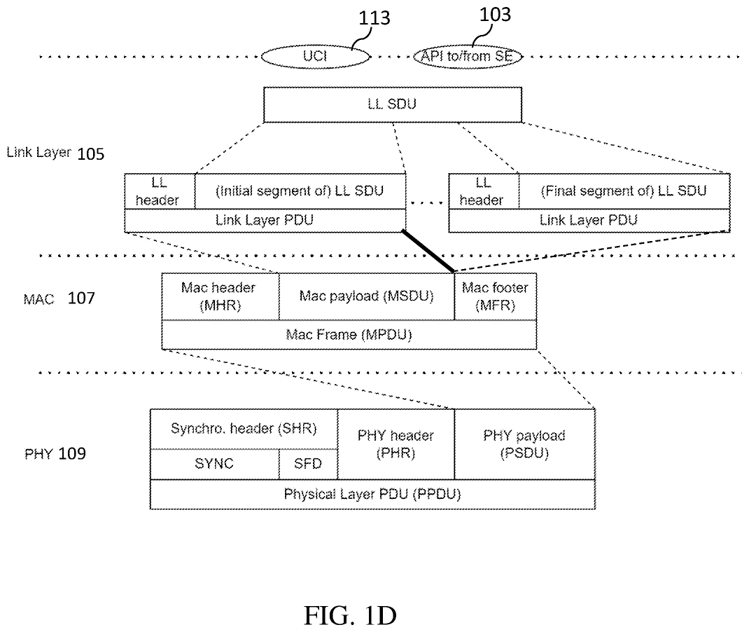

FIG. 1A illustrates an exemplary environment 100 for in-band service discovery and negotiation, according to some embodiments. A user 58 may carry a UWB device 102 in the proximity of a UWB device 104. UWB device 102 and UWB device 104 may each be enabled of UWB communication functions and possibly one or more non-UWB communication functions. UWB device 102 may be a controlee device, and UWB device 104 may be a controller device. The communication between UWB devices 102 and 104 are through a wireless link 106. The controller device (e.g., UWB device 104) may allocate slots (e.g., time slots) and schedule transmission for the communication between UWB devices 102 and 104. Environment 100 may represent various scenarios such as user 58 trying to make a payment at a payment reader, e.g., user 58 trying to pay parking fees at a parking meter, and/or user 58 trying to purchase an item at a point of sales (POS).

FIG. 1B depicts an exemplary system 101 for implementing the in-band service discovery and negotiation according to some embodiments of the present disclosure. System 101 may include UWB device 102 in wireless communication with UWB device 104, as symbolically illustrated by a wireless link 106. UWB device 102 may be a mobile device or an on-board computer. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include smartphones, tablets, and wearable devices. UWB device 102 may be referred to the controlee that listens to the controller (e.g., UWB device 104) and transmits signals/data in slots allocated by the controller.

UWB device 104 may be referred to as the controller that controls the slot allocation to controlee (e.g., UWB device 102). In some embodiments, UWB device 104 may be installed at a parking meter or a POS and may be configured to perform a contention-access period (CAP) phase, a CFP phase, and/or a data phase in a hybrid ranging round, similar to UWB device 102. In some embodiments, UWB device 104 may be a computing unit (e.g., laptop, desktop, mobile phone, tablet, etc.) dedicated for the coordination function, and may or may not be installed at a POS. In one embodiment, the functionality of the UWB device 104 may be implemented in an already-existing physical computing/data processing unit or (nonphysical) server software in a cloud. Wireless link 106 may include a UWB communication interface. The wireless link 106 may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

A discovery and negotiation application 108 is one of the mobile applications installed in the UWB device 102. Discovery and negotiation application 108 may include suitable software and/or hardware to respond to the poll messages (e.g., including the list of services) transmitted by UWB device 104, and may transmit configuration parameters (PHY parameters like RF channel, preamble code, security parameters like session key to derive the scrambled timestamp sequence (STS) keys and the payload encryption key, MAC parameters like the CRC size, etc.) and related data for the chosen service. In some embodiments, discovery and negotiation application 108 generates and sends a response message with a chosen service advertised by UWB device 104, via wireless interface 126, to UWB device 104 to notify UWB device 104 of the chosen service. Discovery and negotiation application 108 may randomly choose one or more slots in the contention-based session/sub-session allocated by UWB device 104. In some embodiments, discovery and negotiation application 108 exchange the configuration parameters for the chosen service for in-band negotiation in a phase allocated by UWB device 104 in a negotiation phase/sub-session/session. In some embodiments, discovery and negotiation application 108 ranges and transmits any related data to UWB device 104 after the negotiation is completed to execute the service. In addition to discovery and negotiation application 108, UWB device 102 may also include one or more applications 120 reside therein. These applications 120 are software modules that may have been pre-packaged with the UWB device 102 or may have been downloaded by a user into the memory (not shown) of the UWB device 102. Some applications 120 may be more user-interactive applications, whereas some other mobile applications, such as discovery and negotiation application 108, may be less user-interactive in nature. For example, some applications include Ethernet-based communication, an application that interacts with cloud, etc. In some embodiments, UWB device 102 is a mobile device and applications 120 may include mobile applications. The applications 120 as well as discovery and negotiation application 108 may be executed by the processor 122 under the control of the mobile operating system 124. UWB device 102 may further include a wireless interface unit 126 to facilitate wireless communication with the UWB device 104 via the wireless link 106. The applications 108, 120 may utilize the wireless interface 126 as needed.

UWB device 104 is shown to include a CPU 130 executing a controller operating system 132. In some embodiments, CPU 130 is relatively high-powered. UWB device 104 may include a discovery and negotiation control application 134 that controls the in-band service discovery and negotiation between UWB devices 102 and 104. In addition to discovery and negotiation control application 134, UWB device 104 may also store in its memory (not shown) other controller-specific applications 136 such as, for example, an application that facilitates Ethernet-based communication, an application that interacts with cloud, and the like. The UWB device 104 may wirelessly communicate with the UWB device 102 via its own wireless interface unit 138. The wireless interface units 126 and 138 may wirelessly transfer data or information between the UWB device 102 and the UWB device 104 using the wireless link 106 as shown. In some embodiments, discovery and negotiation control application 134 generates and transmits/broadcasts a poll message that includes all the services (e.g., data services) provided by the other controller applications 136 in a contention-based session/sub-session. Discovery and negotiation control application 134 may also transmit an allocation of slots (e.g., the size/number of slots) for the contention-based session with the poll message. After receiving the controlee's (e.g., UWB device 102) selection of service, discovery and negotiation control application 134 may schedule a negotiation phase/sub-session/session to exchange configuration parameters (PHY parameters like RF channel, preamble code, security parameters like session key to derive the STS keys and the payload encryption key, MAC parameters like the CRC size, etc.) for the chosen service. After the negotiation is completed, UWB device 104 may execute the chosen service with the negotiated configuration parameters.

FIG. 1C illustrates a UWB signaling diagram 150 between UWB device 104 (e.g., the controller UWB device) and UWB device 102 (e.g., the controlee UWB device) for the implementation of in-band service discovery and negotiation, according to some embodiments. At the beginning of the UWB communication, UWB device 102 may listen to UWB device 104 (or any potential controller UWB device 104) by turning on its receiver and tuning to predetermined settings for a service announcement message 152. UWB device 104 may transmit a service announcement message 154. In some embodiments, service announcement message 154 is part of a poll message that includes a size (e.g., time period and/or the number of slots) of a contention-based session/sub-session, which UWB device 104 allocates for itself to discover new controlee UWB devices and any services a UWB controlee device is interested in. In some embodiments, service announcement message 154 is part of a OWR packet, followed by a poll message. Service announcement message 154 may include a list of the services supported by the upper layers (or applications) of UWB device 104. UWB device 102 may determine a service of interest, select a random slot 156 in the contention-based session/sub-session, and transmit the chosen service to UWB device 104 in a response message 158 after a time of reply T_{reply}. The response message 158 may include information such as time of reply T_{reply} and a response to service announcement message 154 with the chosen service, e.g., the identification (ID) number (and optionally one or more attributes) of the chosen service. The time from UWB device 104 transmits the poll message to the time UWB device 104 receives response message 158 is a time of loop Tₗₒₒₚ. In some embodiments, UWB device 104 computes a time of flight TOF as (Tₗₒₒₚ−T_{reply})/2, and a distance D from UWB device 104 to UWB device 104 as D=TOF×speed of light. In some embodiments, UWB device 104 starts a negotiation session/sub-session after the receipt of response message 158 if distance D is below a predetermined value 160. The negotiation session may be started by a time delay T_{d} after contention-based session/sub-session. In some embodiments, time delay T_{d} may be a predefined parameter for both UWB devices 102 and 104. UWB device 102, if sends response message 158 with a chosen service, may gather configuration parameter for negotiation by the end of time delay T_{d}, e.g., before the start of the negotiation session/sub-session.

The service announcement message 154 and the response to service announcement message 154 may each be a LL message. FIG. 1D illustrates a process to construct a packet for transmission through different layers of a UWB device. A packet, including various data such as user data, may be transmitted from upper layers 103 (e.g., application programming interface and/or a secure element) to a UWB radio interface for transmission to another UWB device. As shown in FIG. 1D, on the transmitter side, a data payload (e.g., LL SDU) may be provided to the UWB system through a UWB control interface (UCI) 113 to a link layer 105. The payload can be segmented and a LL header may be appended to the segment. The LL header and the segment may form the LL packet data unit (PDU). The LL PDU may then be then transmitted to a MAC layer 107. The LL PDU may then be embedded into a MAC payload (or MAC SDU or MSDU). The MSDU may be appended to a MAC header and a MAC footer, forming a MAC frame or MAC protocol data unit (MPDU). The MPDU may be transmitted to a PHY layer 109. The MPDU may then be embedded into a PHY payload (or physical layer convergence procedure SDU or PSDU). The PSDU may be appended to a PHY header and a synchronization header (or SHR), forming a physical layer protocol data unit or (PPDU). The PPDU may then be transmitted to the UWB device (through the UWB radio interface or the SE interface).

On the receiver side, a packet from another UWB device may be received at the PHY layer 109, and may be parsed at the PHY layer 109, the MAC layer 107, and the link layer 105. For example, a link layer PDU may be received at link layer 105 and may be processed. And data and signals may be further transmitted to upper layers 102 through UCI 113. Detailed description of the use of link layer messages in the in-band service discovery and negotiation may be provided in the embodiments below.

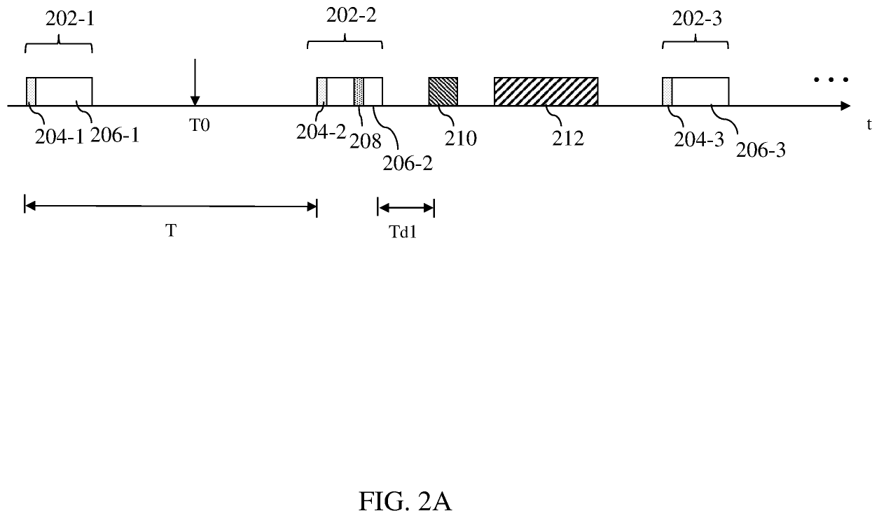

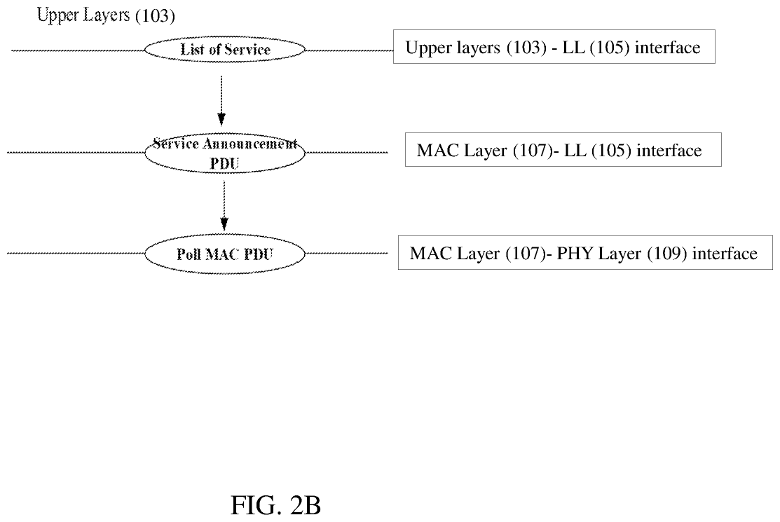

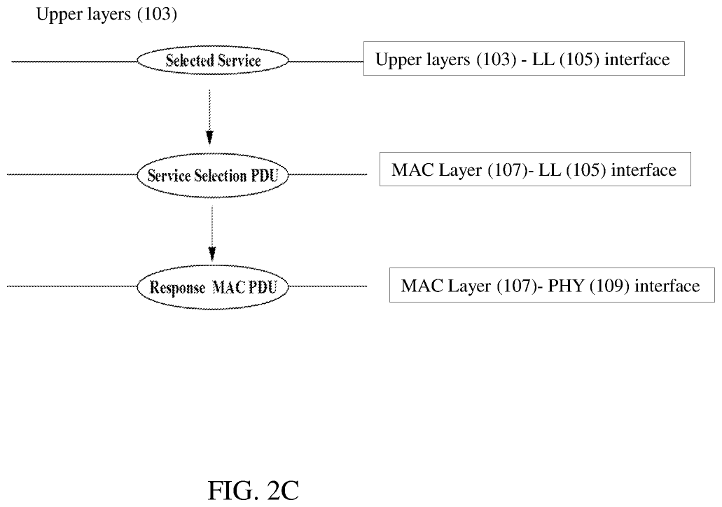

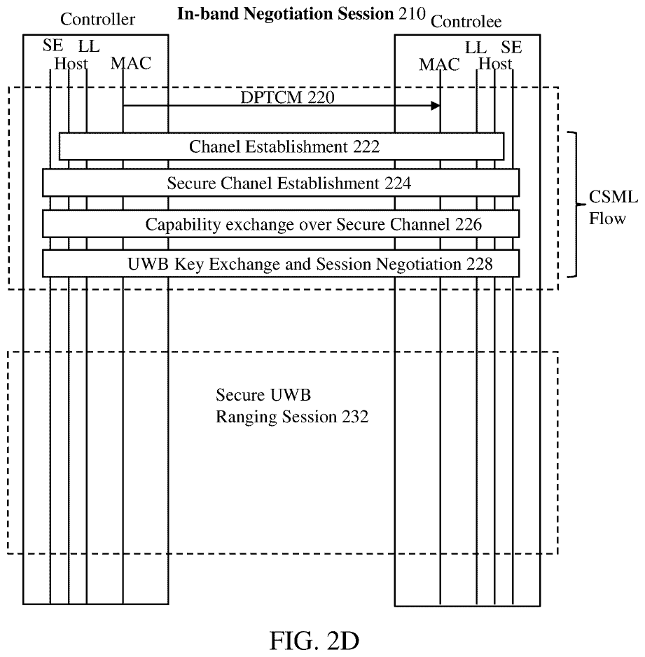

FIGS. 2A-2D illustrate an exemplary in-band service discovery and negotiation, according to some embodiments.

FIG. 2A illustrates a plurality of rounds 202-1, 202-2, . . . , 202-3, . . . , of a contention-based session, scheduled between a controller UWB device (e.g., UWB device 104) and a controlee UWB device (e.g., UWB device 102). The repetition time (e.g., time between the start of two consecutive contention-based rounds) may be T. At the beginning of each round (e.g., 202-1, 202-2, . . . , 202-3, . . . ), the controller UWB device may transmit a respective poll message (204-1, 204-2, 204-3, . . . ), which includes the allocation of the respective contention-based window (206-1, 206-2, 206-3, . . . ). A contention-based window may include a plurality of slots. Each poll message may include the size of the respective contention-based window and a service announcement message (e.g., similar to service announcement message 154) that includes a list of services supported by the upper layers of the controller UWB device (e.g., referring back to the description of upper layers 103 in FIG. 1D).

For example, at the beginning of round 202-1, controller UWB device may send a poll message 204-1 that includes the size of contention-based window 206-1 and a service announcement message that includes a list of services supported by the upper layers of the controller UWB device. No controlee UWB device was detected, or no controlee UWB device responded in contention-based window 206-1. At time TO (after contention-based session 202-1), a controlee UWB device is in a proximity of the controller UWB device, and is tuned to listen to the controller UWB device. At the beginning of round 202-2 that follows round 202-1, the controller UWB device may send a poll message 204-2 that includes the size of contention-based window 206-2 and a service announcement message that includes the list of services. The controlee UWB device may receive poll message 204-2 in round 202-2, and may select a service of interest. The controlee UWB device may then transmit a response message 208 (e.g., similar to response message 158) with the chosen service to the controller UWB device in round 202-2. In some embodiments, the controlee UWB device may randomly choose one or more slot in contention-based window 206-2 to transmit response message 208. The controlcc UWB device may prepare its configuration parameters (PHY parameters like RF channel, preamble code, security parameters like session key to derive the STS keys and the payload encryption key, MAC parameters like the CRC size, etc.) for the chosen service while the controller UWB device schedules a negotiation session 210 after contention-based session 202-2 upon receiving response message 208. In some embodiments, negotiation session 210 is scheduled to be Td1 after contention-based window 206-2 (or round 202-2). In negotiation session 210, the controller UWB device and the controlee UWB device may exchange configuration parameters for the service. In some embodiments, negotiation session 210 may be a data-only session or a data-with-ranging session. In some embodiments, coupling data session with ranging can be a way to enforce security to ensure that the in-band negotiation will happen if (e.g., and only if) the controller UWB device and the controlee UWB device are in a given proximity range. After the negotiation is completed, the controller UWB device may schedule an execution session 212 to execute the service, e.g., measuring distance and/or performing data transfer for the service, etc. In some embodiments, execution session 212 includes a contention-free period (CFP) that includes UWB ranging between the controller UWB device and the controlee UWB device, such as performing a two-way ranging (TWR). In some embodiments, execution session 212 includes one or more rounds, depending on the chosen service. After the service execution is completed, the controller UWB device may send a poll message 204-3 at the beginning of round 202-3. The poll message 204-3 may include the size of contention-based window 206-3 and a service announcement that includes the list of services.

Below is an example of a set of predefined parameters in the scheduling of a round (e.g., 202-1, 202-2, . . . ) in a contention-based session:
Session ID=0FFF0
Minimum set of PHY UWB parameters of the session: UWB channel, Ipatov preamble ID, Start of Frame Delimiter (SFD) ID
MAC cyclic redundancy check (CRC) size=2B, PSDU bitrate=6.8Mbps, Modulation=BPRF
Digest value
Repetition period T=1 s

This session is defined to announce the supported services on the controller UWB device and to discover the controlee UWB devices that are interested in any of the offered services. In some embodiments, at each T, the controller UWB device schedules the session 0xFFF0 to announce the services it supports (e.g., for the parking meter). The upper layers of the controller UWB device may provide a list of supported services to the UWB system (UWBS). In some embodiments, each service is identified by a unique ID and possibly/optionally with a few attributes. In some embodiments, this session is an always-on session.

The link layer (LL) of the controller UWB device may construct a LL PDU for service announcement (referring back to the description of FIG. 1D). The service announcement message (e.g., the LL PDU) may be transmitted in a LL service data unit (SDU) embedded in the poll message (e.g., 204-1, 204-2, . . . ), referring back to the description of FIG. 1D. The LL PDU may be constructed by a dedicated LL controller or a general controller (e.g., CPU 130). In some embodiments, the LL PDU is encapsulated in a MAC data message and is transmitted in the poll message (e.g., 204-1, 204-2, . . . )

In some embodiments, the LL SDU may include a first field indicating a message type and a second field indicating the list of services supported by the controller UWB device. In an example, the first field may include “Msg type=0xa0,” which indicates the service announcement. The second field may include “List of services” that includes IDs (and optionally attributes) of different services. An example of the “List of services” is provided below:
ID=1 immediate payment
ID=2: payment with subscription In some embodiments, when the controller UWB device receives a response message (e.g., 208) that includes a chosen service from a controlee UWB device, the controller UWB device may schedule an in-band negotiation session (e.g., 210). This scheduling may also schedule the time to start the negotiation session, e.g., a time delay (e.g., Td1) after a round (e.g., 202-2 or the service announcement session). In some embodiments, if no chosen service (e.g., response message) from the controlee is received, the controller UWB device does not start the negotiation session. Below is an example of a set of predefined parameters in the scheduling of an in-band negotiation session.
Session ID=0xFFF1
Minimum set of PHY UWB parameters of the session: UWB channel, Ipatov preamble ID, Start of Frame Delimiter (SFD) ID
MAC cyclic redundancy check (CRC) size=2B, PSDU bitrate=6.8Mbps, Modulation=BPRF
Digest value
LL mode=Connection-less
Number of slot=100
DTPCM (Data Transfer Control Message or MAC slot allocation) is a predefined slot allocation pattern
Delay vs the service announcement session

FIG. 2D illustrates a signaling diagram of an in-band negotiation session 210 between the controller UWB device (“Controller”) and the controlee UWB device (“Controlee”), according to some embodiments. As shown in FIG. 2D, after receiving a response message with a chosen service, the controller UWB device may schedule a negotiation session with the above parameters. In the negotiation session, the controller UWB device may transmit to the controlee UWB device a default in-band negotiation DPTCM 220 in a MAC layer message (e.g., constructed and parsed by the MAC layers 107 of both UWB devices). The upper layers (e.g., 103 or “Host”) of the two UWB devices may perform a connection-less (CL) LL channel establishment 222. The secure elements (e.g., 103) of both the UWB devices may perform a secure channel establishment 224, a capability exchange over secure channel 226, and a UWB key exchange and session negotiation for the secure UWB ranging over secure channel 228.

In some embodiments, a secure UWB ranging session 232 may be performed between the two UWB devices using the negotiated parameters (e.g., in steps 226 and 228). For example, the controller UWB device may perform the UWB ranging session 232 to determine a distance to the controlee UWB device before service execution session.

FIG. 2B illustrates the construction of a LL PDU as part of the poll message by the controller UWB device. The list of services supported by the upper layers 103 may be collected and sent to LL 105 through the upper layers (103)-LL (105) interface, and are constructed as a service announcement PDU (e.g., a LL PDU) in the LL 105. The service announcement PDU is then sent to the MAC layer 107 through the MAC layer (107)-LL (105) interface. The service announcement PDU is then constructed in the MAC layer 107 in a MAC PDU (“Poll MAC PDU”) transmitted to the PHY layer 109 through the MAC layer (107)-PHY layer (109) interface. The PHY layer 109 may then transmit the poll message appending the MAC PDU.

In some embodiments, the controlee UWB device is in the proximity of the controller UWB device (e.g., a user with a mobile device is approaching a parking meter, the controlee UWB device (e.g., the discovery and negotiation application 108) may listen to or seek for a contention-based session (with session ID=0xFFF0), such as 202-2. For example, the controlee UWB device may turn its UWB receiver for a T phase, with the predefined PHY and MAC configuration. When the controlee UWB device receives the poll message (e.g., 204-2) for this session, it reads the list of services. The controlee UWB device may forward the list to its upper layers. If an application in the upper layers is interested with one of the listed services (e.g., payment with subscription), the controlee UWB device may reply in a random slot of the contention-based window with a response message (e.g., 208) that includes the ID of the service the controlee UWB device is interested in. For this purpose, it provides to the LL the ID (and possibly the attributes the application is interested in). The LL constructs a LL PDU service selection. It is then encapsulated in a MAC data message and appended in the response message. In some embodiments, the LL PDU may include a first field indicating a message type and a second field indicating the list of services chosen by the controlee UWB device. In an example, the first field may include “Msg type=0xa0,” which indicates the service selection. The second field may include “ID of the selected service” that includes IDs (and optionally one or more attributes) of the chosen service.

FIG. 2C illustrates the construction of a LL PDU as part of the response message by the controlee UWB device. The upper layers 103 may select a service of interest and send the service ID (and optionally one or more attributes) to LL layer 105 through the upper layers (103)-LL (105) interface. The service ID and any attributes may be constructed as a service selection PDU (e.g., a LL PDU) in the LL 105. The service selection PDU is then sent to the MAC layer 107 through the MAC layer (107)-LL (105) interface. The service selection PDU is then constructed in the MAC layer 107 in a MAC PDU (“Response MAC PDU”) transmitted to the PHY layer 109 through the MAC layer (107)-PHY layer (109) interface. The PHY layer 109 may then transmit the response message appending the MAC PDU.

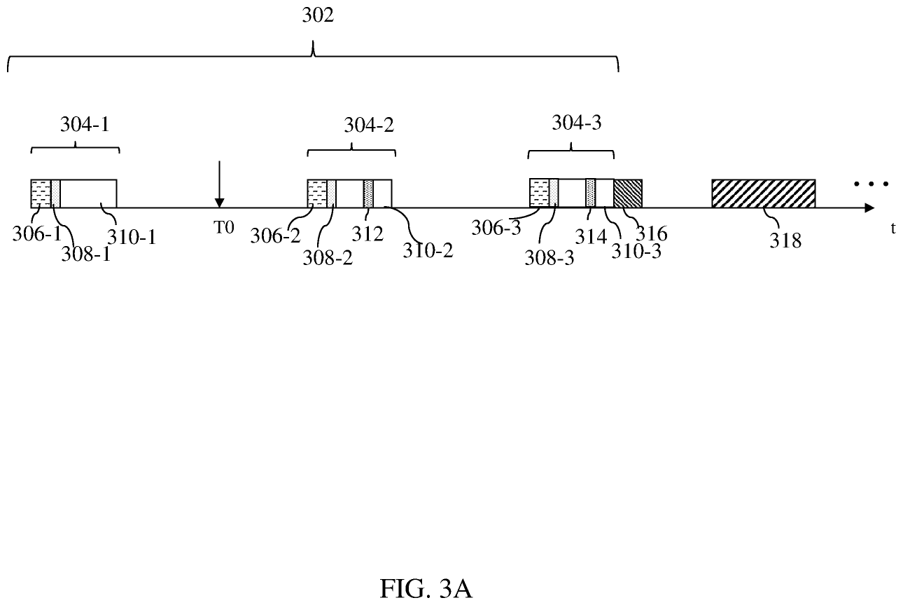

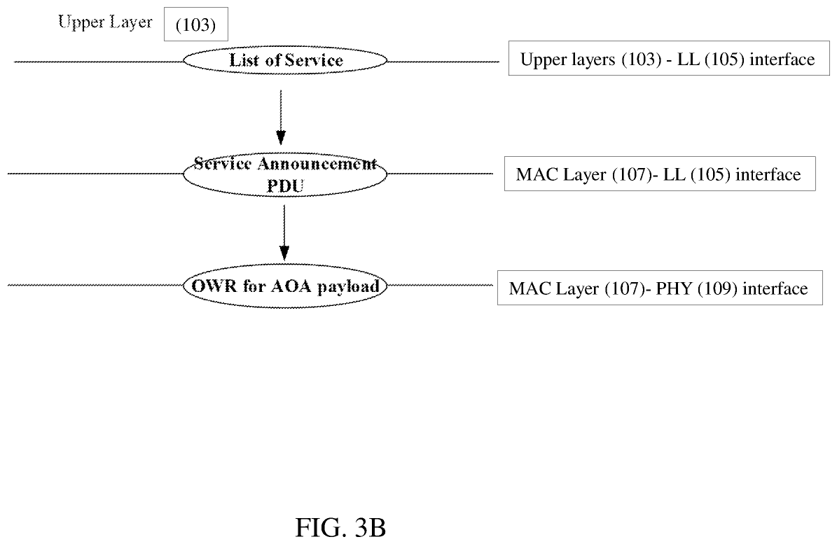

FIGS. 3A-3C illustrate an exemplary in-band service discovery and negotiation in a hybrid session, according to some embodiment.

FIG. 3A illustrates a hybrid session 302 and a plurality of hybrid ranging rounds 304-1, 304-2, . . . , 304-3, . . . , scheduled between a controller UWB device (e.g., UWB device 104) and a controlee UWB device (e.g., UWB device 102). Each of the hybrid ranging rounds may include a one-way ranging (OWR) sub-session (e.g., 306-1, 306-2, 306-3, . . . ) and a contention-based window (e.g., 310-1, 310-2, 310-3, . . . ). A controlee UWB device may determine/measure an angle of view from the controller UWB device based on the OWR. In the OWR sub-session, the controller UWB device may advertise/broadcast a OWR packet without expecting a response. Different from the embodiments described in FIGS. 2A-2D, the controller UWB device may append/embed a service announcement message (e.g., similar to service announcement message 154) to/in the OWR packet for service announcement. The controller UWB device may also transmit a poll message (e.g., 308-1, 308-2, 308-3, . . . ) in the contention-based round following a respective OWR to discover controlee UWB devices that are interested in any broadcasted/advertised services in the OWR session. If the controlee UWB device is interested in one of the services, the controlee UWB device may transmit a response message (e.g., 312 and 314) with the selected service (e.g., ID and optionally one or more attributes of the service) in a random slot in the respective contention-based window. The controller UWB device may schedule a negotiation session/sub-session (e.g., 316) in the following hybrid ranging round for the negotiation of configuration parameters for the chosen service. If no controlee responds in the contention-based session, the negotiation sub-session is not scheduled. In some embodiments, a negotiation session (e.g., a data sub-session), in which the controller and controlee UWB devices perform negotiation for the configuration parameters of the session to execute the chosen service, is scheduled after hybrid ranging round 304-2. In some embodiment, the in-band service discovery and negation may further include a service execution session 318 in which the chosen service is executed.

At the beginning of each hybrid ranging round (e.g., 304-1, 304-2, 304-3, . . . ), the controller UWB device may perform a OWR session in which a OWR packet is transmitted. The OWR packet may include a service announcement message that includes a list of services supported by the upper layers of the controller UWB device (e.g., referring back to the description of upper layers 103 in FIG. 1D). The controller UWB device may then transmit a respective poll message 308-1, 308-2, 308-3, . . . after the respective OWR packet. Each poll message may include the slot allocation of the respective contention-based window (e.g., 310-1, 310-2, 310-3, . . . ).

For example, no controlee UWB device responded in the contention-based window 310-1. At time T0 (after contention-based window 310-1), a controlee UWB device is in a proximity of the controller UWB device, and is tuned to listen to the OWR of the controller UWB device. At the beginning of hybrid ranging round 304-2 that follows hybrid ranging round 304-1, the controller UWB device may first transmit a OWR packet in the OWR session 306-2 at the beginning of hybrid ranging round 304-2. The OWR packet includes a service announcement with the list of supported services. The controller UWB device may then transmit a poll message 308-2 that includes the size of contention-based window 310-2. The controlee UWB device may receive the OWR packet and poll message 308-2, and may select a service of interest. The controlee UWB device may then transmit a response message 312 (e.g., similar to response message 158) with the chosen service to the controller UWB device in the same contention-based sub-session 310-2. In some embodiments, the controlee UWB device may randomly choose one or more slot in contention-based window 310-2. The controlee UWB device may prepare its configuration parameters (PHY parameters like RF channel, preamble code, security parameters like session key to derive the STS keys and the payload encryption key, MAC parameters like the CRC size, etc.) for the chosen service while the controller UWB device schedules a negotiation session 316 in the next hybrid ranging round (e.g., 304-3) after contention-based sub-session 310-3. In some embodiments, negotiation sub-session 316 is scheduled to be immediately after contention-based window 310-3. In negotiation session 316, the controller UWB device and the controlcc UWB device may exchange configuration parameters for the service. In some embodiments, negotiation session 316 may be a data-only session or a data-with-ranging session. In some embodiments, coupling data session with ranging can be a way to enforce security to ensure that the in-band negotiation will happen if (e.g., and only if) the controller UWB device and the controlee UWB device are in a given proximity range. After the negotiation is completed, the controller UWB device may schedule an execution session 318 to execute the service, e.g., measuring distance and/or performing data transfer for the service, etc. In some embodiments, execution session 318 includes a CFP that includes UWB ranging between the controller UWB device and the controlee UWB device, such as performing a TWR. In some embodiments, execution session 318 includes one or more rounds, depending on the chosen service.

In some embodiments, the controller UWB device schedules a negotiation session/sub-session/phase (e.g., 316, a data transfer phase) in the ranging round n+1 (e.g., 304-3) and allocates slots in ranging round n+1 for the negotiation sub-session, to support the in-band negotiation. This may be triggered if the controller UWB device is in a predefined distance and/or at a given angle (e.g., determined thanks to the OWR message). The configurations of the OWR sub-session, contention-based sub-session and negotiation sub-session are predefined parameters and are known by the controlee UWB device.

FIG. 3B illustrates the construction of a LL PDU as part of the OWR packet by the controller UWB device. The list of services supported by the upper layers 103 may be collected and sent to LL 105 through the upper layers (103)-LL (105) interface, and are constructed as a service announcement PDU (e.g., a LL PDU) in the LL 105. The service announcement PDU is then sent to the MAC layer 107 through the MAC layer (107)-LL (105) interface. The service announcement PDU is then constructed in the MAC layer 107 in an angle-of arrival (AOA) payload of a OWR packet and is transmitted to the PHY layer 109 through the MAC layer (107)-PHY layer (109) interface. The PHY layer 109 may then transmit the OWR packet. The construction of a LL PDU as part of the response message by the controlee UWB device may be similar to that described in FIG. 2C and is not repeated herein.

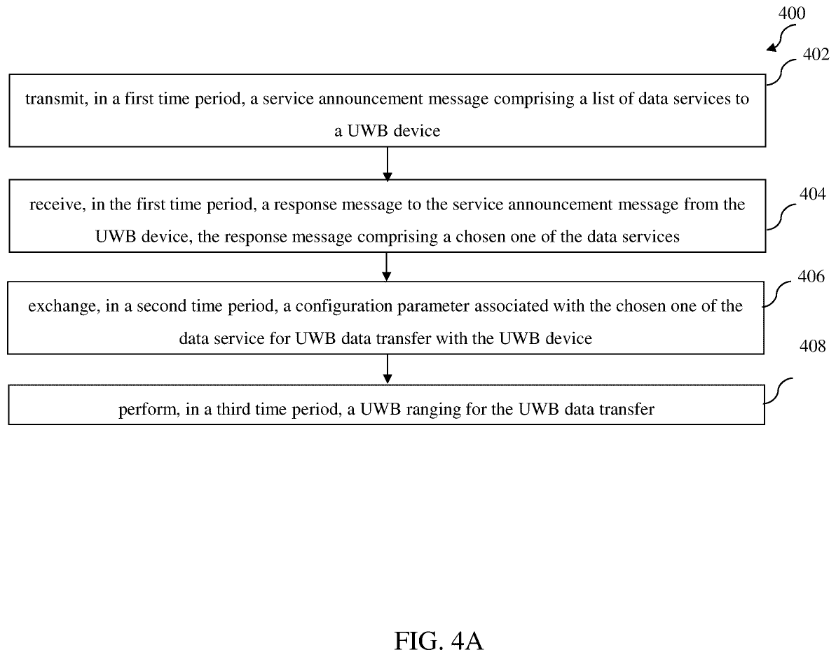

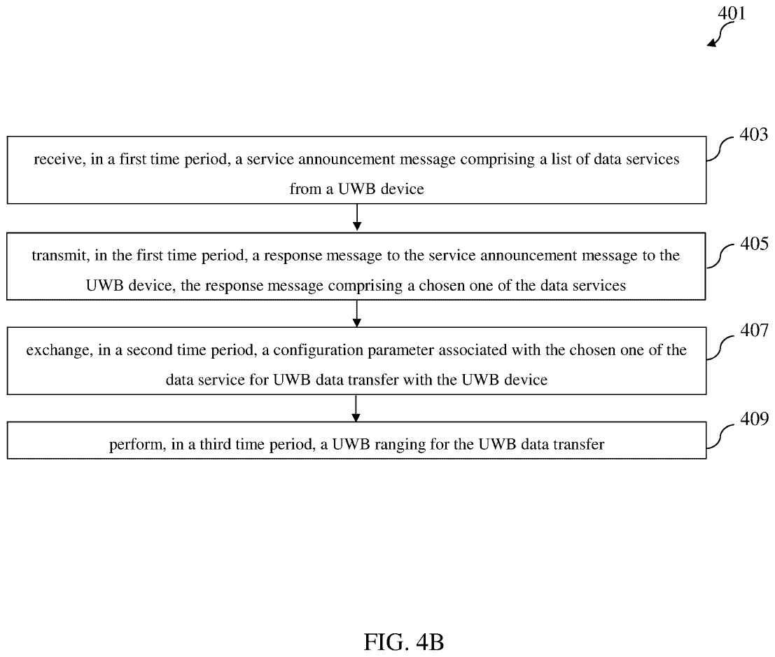

FIG. 4A is a flowchart of a method 400 for a controller UWB device to perform in-band service discovery and negotiation in a UWB system, according to some embodiments of the present disclosure. Method 400 is merely an example, and is not intended to limit the present disclosure beyond what is explicitly recited in the claims. Additional operations can be provided before, during, and after the method 400, and some operations described can be replaced, eliminated, or moved around for additional embodiments of method 400. For ease of illustration, FIG. 4A is described in connection with FIGS. 1C, 2A, and 3A.

At step 402, a service announcement message is transmitted to a UWB device in a first time period. The service announcement message includes a list of data services. Referring to the description of FIGS. 1C, 2A, and 3A, a poll message (e.g., 154, 204-2) or a OWR packet (e.g., 154, 306-2) is transmitted to a controlee UWB device (e.g., UWB device 102) by the controller UWB device (e.g., UWB device 104) in a first time period (e.g., 202-2, 304-2). The poll message and the OWR packet each includes a list of data services supported by the controller UWB device.

At step 404, a response message to the service announcement message from the UWB device is received in the first time period. The response message includes a chosen one of the data services. Referring back to the description of FIGS. 1C, 2A, and 3A, a response message (e.g., 158, 208, 312) is received in the first time period (e.g., 202-2, 304-2) by the controller UWB device (e.g., UWB device 104). The response message includes a chosen one of the data services carried by the poll message.

At step 406, a configuration parameter associated with the chosen one of the data service for UWB data transfer is exchanged in a second time period, with the UWB device. Referring back to the description of FIGS. 1C, 2A, and 3A, configuration parameters such as PHY parameters like RF channel, preamble code, security parameters like session key to derive the STS keys and the payload encryption key, MAC parameters like the CR size, etc., are exchanged between the controller UWB device and the controlee UWB device in the second time period (e.g., 210, 316).

At step 408, a UWB ranging for the UWB data transfer is performed in a third time period. Referring back to the description of FIGS. 1C, 2A, and 3A, a UWB ranging (e.g., TWR) for the data transfer of the chosen service is performed between the controller UWB device and the controlee UWB device in a third time period (e.g., 212, 318).

FIG. 4B is a flowchart of a method 401 for a controlee UWB device to perform in-band service discovery and negotiation in a UWB system, according to some embodiments of the present disclosure. Method 401 is merely an example, and is not intended to limit the present disclosure beyond what is explicitly recited in the claims. Additional operations can be provided before, during, and after the method 401, and some operations described can be replaced, eliminated, or moved around for additional embodiments of method 401. For ease of illustration, FIG. 4B is described in connection with FIGS. 1C, 2A, and 3A.

At step 403, a service announcement message with a list of data services from a UWB device is received in a first time period. Referring back to the description of FIGS. 1C, 2A, and 3A, a poll message (e.g., 154, 204-2) or a OWR packet (e.g., 154, 306-2) is received by a controlee UWB device (e.g., UWB device 102) from the controller UWB device (e.g., UWB device 104) in a first time period (e.g., 202-2, 304-2). The poll message and the OWR packet each includes a list of data services supported by the controller UWB device.

At step 405, a response message to the service announcement message is transmitted to the UWB device in the first time period. The response message includes a chosen one of the data services. Referring back to the description of FIGS. 1C, 2A, and 3A, a response message (e.g., 158, 208, 312) is transmitted in the first time period (e.g., 202-2, 304-2) by the controlee UWB device (e.g., UWB device 102). The response message includes a chosen one of the data services carried by the poll message.

At step 407, a configuration parameter associated with the chosen one of the data service for UWB data transfer is exchanged with the UWB device in a second time period. Referring back to the description of FIGS. 1C, 2A, and 3A, configuration parameters such as PHY parameters like RF channel, preamble code, security parameters like session key to derive the STS keys and the payload encryption key, MAC parameters like the CR size, etc., are exchanged between the controller UWB device and the controlee UWB device in the second time period (e.g., 210, 316).

At step 409, a UWB ranging for the UWB data transfer is performed in a third time period. Referring back to the description of FIGS. 1C, 2A, and 3A, a UWB ranging (e.g., TWR) for the data transfer of the chosen service is performed between the controller UWB device and the controlee UWB device in a third time period (e.g., 212, 318).

Those skilled in the art will recognize improvements and modifications to the preferred embodiments of the present disclosure. All such improvements and modifications are considered within the scope of the concepts disclosed herein and the claims that follow.

1. A method for in-band service discovery in ultra-wideband (UWB) communication, comprising:
transmitting, in a first time period, a service announcement message comprising a list of data services to a UWB device;
receiving, in the first time period, a response message to the service announcement message from the UWB device, the response message comprising a chosen one of the data services;
exchanging, in a second time period, a configuration parameter associated with the chosen one of the data service for UWB data transfer with the UWB device; and
performing, in a third time period, a UWB ranging for the UWB data transfer.

2. The method of claim 1, wherein the first time period comprises a UWB contention-based period to discover the UWB device and a plurality of slots following the service announcement message.

3. The method of claim 2, wherein:
the service announcement message is embedded in a poll message at a beginning of the first period before the UWB contention-based period.

4. The method of claim 1, wherein the second time period comprises a UWB data period subsequent to the first period by a predetermined time delay.

5. The method of claim 4, further comprising scheduling the second time period subsequent to the first period by the predetermined time delay upon receiving the response message.

6. The method of claim 4, further comprising performing a UWB ranging operation with the UWB device in the second time period to obtain a distance to the UWB device.

7. The method of claim 2, wherein the service announcement message comprises a link layer message and each of the data services is associated with an identification number.

8. The method of claim 4, wherein the response message comprises a link layer message and comprises an identification number of the chosen one of the data services.

9. The method of claim 8, wherein the response message further comprises an attribute of the chosen one of the data services.

10. The method of claim 2, wherein the service announcement message is part of a one way ranging (OWR) packet located in a time slot at the beginning of the first time period before the UWB contention-based period.

11. The method of claim 10, wherein the first time period and the second time period are hybrid ranging periods of a hybrid session.

12. The method of claim 1, wherein the UWB ranging comprises a two-way ranging (TWR).

13. The method of claim 1, wherein the service announcement message is constructed on a predefined configuration of a physical layer and a medium access control (MAC) layer.

14. A method for in-band service discovery in ultra-wideband (UWB) communication, comprising:
receiving, in a first time period, a service announcement message comprising a list of data services from a UWB device;
transmitting, in the first time period, a response message to the service announcement message to the UWB device, the response message comprising a chosen one of the data services;
exchanging, in a second time period, a configuration parameter associated with the chosen one of the data service for UWB data transfer with the UWB device; and
performing, in a third time period, a UWB ranging for the UWB data transfer.

15. The method of claim 14, wherein the first time period comprises a UWB contention-based period.

16. The method of claim 14, wherein the second time period comprises a UWB data period subsequent to the first period by a predetermined time delay.

17. The method of claim 16, further comprising, preparing the configuration parameter for the exchanging by an end of the predetermined time delay and based on the response message.

18. The method of claim 14, wherein the service announcement message comprises a link layer message and each of the data services is associated with an identification number.

19. The method of claim 14, wherein;
the response message comprises a link layer message and comprises an identification number of the chosen one of the data services-; and
the response message further comprises an attribute of the chosen one of the data services.

20. An ultra-wideband (UWB) device, comprising
a transceiver operable to perform a UWB communication;
a memory for storing program instructions and a list of data services, each of the data services being associated with an identification number; and
a processor coupled to the transceiver and to the memory, wherein the processor is operable to execute the program instructions, which, when executed by the processor, cause the UWB device to perform the following to facilitate in-band service discovery for a UWB device:
transmitting, in a first time period, a service announcement message comprising a list of data services to the UWB device;
receiving, in the first time period, a response message to the service announcement message from the UWB device, the response message comprising a chosen one of the data services;
exchanging, in a second time period, a configuration parameter associated with the chosen one of the data service for UWB data transfer with the UWB device; and
performing, in a third time period, a UWB ranging for the UWB data transfer.

22-33. (canceled)
